(19) United States
(12) Patent Application Publication
(10) Pub. No.: US 2017/0228632 A1
(43) Pub. Date: Aug. 10, 2017

(54) IDENTIFICATION DOCUMENTS WITH RADIATION CURABLE MATERIAL AND RELATED METHODS

(71) Applicant: ENTRUST DATACARD CORPORATION, Shakopee, MN (US)

(72) Inventors: Roman Thomas KNIPP, Shakopee, MN (US); Pauline UKPABI, Shakopee, MN (US); Utpal R. VAIDYA, Shakopee, MN (US); Thomas J. WAGENER, Shakopee, MN (US); Brian BEECH, Shakopee, MN (US)

(21) Appl. No.: 15/424,217

(22) Filed: Feb. 3, 2017

Related U.S. Application Data
(60) Provisional application No. 62/291,954, filed on Feb. 5, 2016.

(51) Int. Cl. G06K 19/18; B29C 59/00; B29C 35/08; B42D 25/305; B42D 25/23; B42D 25/24; B42D 25/425; B42D 25/41; B29C 59/02; G06K 19/12

(52) U.S. Cl. CPC G06K 19/18; B29C 59/02; B29C 59/002; B29C 35/0805; G06K 19/12; B42D 25/23; B42D 25/24; B42D 25/425; B42D 25/41; B42D 25/305; B29C 2035/0827; B29L 2009/005

(57) ABSTRACT

Systems and methods wherein one or more processing operations on an identification document occur after a radiation curable material is applied to a surface of the identification document but before the radiation curable material is fully cured. The one or more processing operations can occur before any curing of the radiation curable material takes place. Alternatively, the one or more processing operations can occur after the radiation curable material has been partially cured, and before the radiation curable material is fully or completely cured.

### FIELD

This description relates to performing processing operations on surfaces of identification documents including, but not limited to, plastic or composite cards such as financial (e.g., credit, debit, or the like) cards, driver's licenses, national identification cards, business identification cards, gift cards, and other plastic or composite cards which bear personalized data unique to the cardholder and/or which bear other card information, as well as passports and pages of passports.

### BACKGROUND

The use of ultra-violet (UV) curable inks and coatings in identification document personalization is known. It is known to apply a UV curable topcoat to a surface of an identification document to improve the durability of the identification document. Some commonly used UV curable topcoats are liquid compositions and are fully cured once they are applied to the identification document before performing any other processing operations on the identification document. Some UV curable topcoats come in a ribbon form where the topcoat is applied from the ribbon onto the identification document. Typically, these ribbon-based UV curable topcoats are also cured immediately after application to the identification document.

However, a completely cured UV curable material also presents challenges in some subsequent processing steps that take place in order to fully process an identification document after the UV curable material is applied. For example, embossing of a card, such as a credit card, that has been printed with UV curable ink and/or UV curable topcoat that is fully cured may result in cracking of the card surface at the embossed characters. In addition, additional ink printing and/or foil application, such as topping foil or hot stamped foil, may not adequately adhere to a fully cured ink or topcoat.

### SUMMARY

Systems and methods are described herein wherein one or more processing operations on an identification document occur after a radiation curable material is applied to a surface of the identification document but before the radiation curable material is fully cured. In one embodiment, the one or more processing operations can occur before any curing of the radiation curable material takes place. In another embodiment, the one or more processing operations can occur after the radiation curable material has been partially cured, and before the radiation curable material is fully or completely cured.

The radiation curable material can be any radiation curable material that can be applied to a surface of an identification document. For example, the radiation curable material can include, but is not limited to, a topcoat, a printing ink, a protective varnish, or combinations thereof. In one embodiment, the radiation curable material is curable by exposing the material to UV radiation. However, the radiation curable material can be curable by other forms of radiation.

The identification document can be any document that bears personalized data unique to the intended document holder and/or which bears other document data or information. Example of identification documents with which the systems and methods described herein can be used include, but are not limited to, plastic or composite cards such as financial (e.g., credit, debit, or the like) cards, driver's licenses, national identification cards, business identification cards, gift cards, and other plastic or composite cards which bear personalized data unique to the cardholder and/or which bear other card information, as well as passports and pages of passports.

In one embodiment, printing can be applied to a surface of a plastic card substrate using any desired printing technology and a radiation curable topcoat can be applied to the plastic card substrate to protect the printing. The topcoat protected card can then be subjected to further processing (e.g., embossing, indenting, hot stamping) and thereafter fully cured by exposing the card to radiation, such as UV radiation. In one embodiment, the radiation curable topcoat can be applied using a hot roll laminator.

In one embodiment, the plastic card substrate can be an identification card and can include an image of the intended holder of the card on a surface of the card. In other embodiments, the plastic card can be a financial card (e.g., credit card, debit card) and include a magnetic stripe and/or smart chip.

In one embodiment, multi-color printing on a surface of an identification document, such as a card, can occur using a drop-on-demand printing process and radiation curable ink. A color image can be produced by printing using yellow, magenta, cyan, and black, one color at a time. After each color is applied, the color can be exposed to a relatively low dose of radiation which partially cures each ink color to prevent adverse intermingling of the colors. Optionally, a radiation curable protective varnish can be applied over the printed image and the protective varnish can be partially cured by exposing it to radiation. Thereafter, processing of the document can occur, such as embossing characters, applying a colorant to the embossed characters, indenting characters, additional printing using thermal printing and/or a laser, and/or hot stamping. After the processing is complete, the identification document can be transported to a curing station(s) where full curing of the inks and optional protective varnish is achieved by applying suitable radiation energy.

In another embodiment, a radiation curable protective varnish or radiation curable topcoat can be applied to a surface of an identification document, such as a card. A surface of the identification document is first printed using any desired print technology including, but not limited to, thermal printing, laser marking, or the like. Thereafter, the radiation curable protective varnish or the radiation curable topcoat can be applied to the surface to protect the printing. The radiation curable protective varnish or the radiation curable topcoat can then be partially cured with a low dose of radiation. In some embodiments, the partial curing may not be required. Thereafter, processing of the document occurs, such as embossing characters, applying a colorant to the embossed characters, indenting characters, additional printing, and/or hot stamping. After the processing is complete, the document can be transported to a curing station(s) where full curing of the protective varnish or the radiation curable topcoat is achieved by applying suitable radiation energy.

The resulting identification document has improved visual quality and improved durability from processing operations such as embossing characters, topping the embossed characters, indenting characters, printing, applying a hot stamp, and other document processing operations.

### DRAWINGS

FIG. 1 depicts one embodiment of a method described herein.

FIG. 2 depicts another embodiment of a method described herein.

FIG. 3 illustrates an embodiment of an identification document processing system described herein.

FIG. 4 illustrates an embodiment of an identification document described herein.

### DETAILED DESCRIPTION

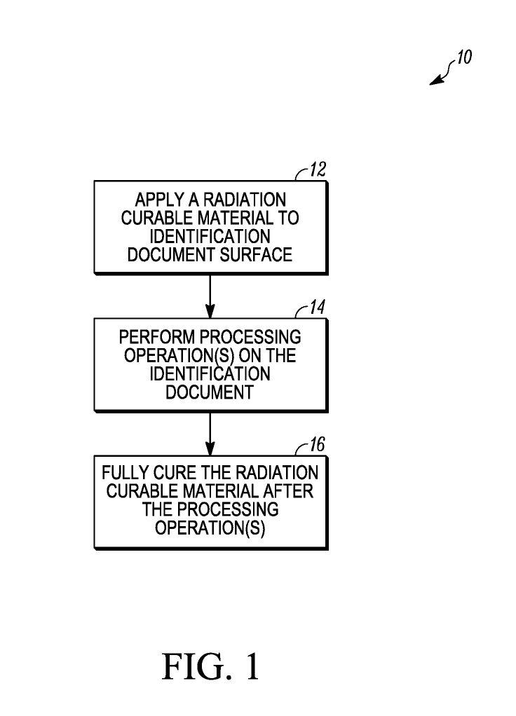

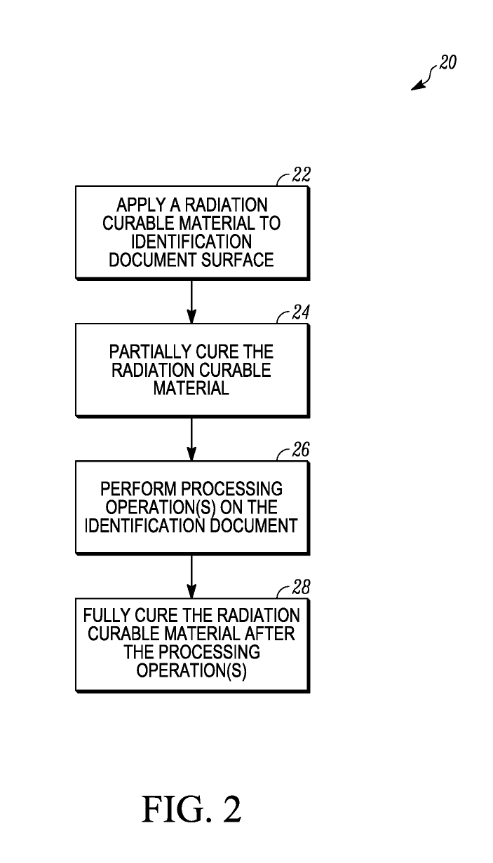

Various embodiments of systems and methods are described below where one or more processing operations on an identification document occur after a radiation curable material is applied to a surface of the identification document but before the radiation curable material is fully cured. In one embodiment described in FIG. 1, the one or more processing operations can occur before any curing of the radiation curable material takes place. In another embodiment described in FIG. 2, the one or more processing operations can occur after the radiation curable material has been partially cured, and before the radiation curable material is fully or completely cured.

Unless otherwise defined in the description or claims, partial curing refers to a process where the radiation curable material applied to the surface of the identification document is exposed to radiation, such as UV radiation, to cause the radiation curable material to undergo a partial or incomplete chemical reaction to partially change properties of the radiation curable material. Any degree of partial curing can be implemented as long as the subsequent one or more processing operations on the identification document can take place without damaging the identification document and/or additional printing and/or foil application, such as topping foil or hot stamped foil, can adequately adhere.

Unless otherwise defined in the description or claims, full or complete curing refers to a process where the radiation curable material applied to the surface of the identification document is exposed to radiation, such as UV radiation, to cause the radiation curable material to undergo a chemical reaction so that the properties of the radiation curable material are at a level suitable for end use.

The radiation curable material can be any radiation curable material that can be applied to a surface of an identification document. For example, the radiation curable material can include, but is not limited to, a radiation curable topcoat material that is applied to a select portion or portions of the surface, or to the entire surface, of the identification document, one or more radiation curable printing inks used to print data on a surface of the identification document, or a protective radiation curable varnish that is applied over a select portion or portions of the surface, or to the entire surface, of the identification document. In the case of radiation curable printing inks, a single ink of a single color can be used for performing monochromatic printing. In another embodiment, in the case of multi-color printing, primary colors such as yellow, magenta, cyan and optionally black can be utilized.

In one embodiment, the radiation curable material can be cured by exposing the material to UV radiation. However, the radiation curable material can be curable by other forms of radiation. Examples of other suitable forms of radiation include, but are not limited to, microwave, x-ray, e-beam, visible light, infrared, and the like.

The techniques described herein can be applied to any type of document, but are especially beneficial for processing identification documents. An identification document can be any document that bears personalized data unique to the intended document holder and/or which bears other document data or information. Example of identification documents with which the systems and methods described herein can be used include, but are not limited to, plastic or composite cards such as financial (e.g., credit, debit, or the like) cards, driver's licenses, national identification cards, business identification cards, gift cards, and other plastic or composite cards which bear personalized data unique to the cardholder and/or which bear other card information, as well as passports and pages of passports.

Commercially available UV curable inks are sold under, for example, the trade name Jet UV Platform, Stretch UV Platform, PUK250754 by Collins Inkjet of Cincinnati, Ohio, and under the tradename EtiJet-ULK by SunJET DIC Inkjet Solutions of Amelia, Ohio. Commercially available UV curable varnishes are sold under, for example, the tradename PUL244859 Clear by Collins Inkjet of Cincinnati, Ohio. Commercially available UV curable topcoats are sold under, for example, the tradename CardGard™ by Entrust Datacard Corporation of Shakopee, Minn.

FIG. 4 illustrates an example of an identification document in the form of a card 50. The card 50 includes a first or front surface 52 and a second or rear surface (not visible). The radiation curable material described herein can be applied to the front surface 52 and/or to the rear surface.

The front surface 52 and the rear surface can contain various types of data and features depending upon the type of card 50. For example, in the case of a credit card, the front surface 52 may contain a credit card number that is embossed or printed, the cardholders name, an expiration date, a verification or CCV number, and logos and/or other graphics related to the card issuer. An integrated circuit chip may also be exposed from the front surface 52. The rear surface may include a magnetic stripe, a signature panel, a verification or CCV number, card issuer contact information, and the like. Some cards 50, such as a driver's license, can include a printed photograph of the license holder, name and address information, other personal information, a license number, while the rear surface may contain a magnetic stripe and a bar code. Some cards may also include security features such as holograms, printed graphics, microprinting, printed watermarks, and the like. The specific types of data and features available on identification documents are too numerous to mention each one specifically.

A processing operation, unless otherwise defined in the description or claims, refers to an operation that occurs to the identification document or to a surface of the identification document that results in a physical change to the identification document or to a surface thereof. Examples of processing operations include, but are not limited to, embossing characters, topping the embossed characters with color material from a foil, indenting characters into the surface, printing characters, images or other data on the surface using thermal printing, a laser or other printing technique, or hot stamping of a security feature.

Referring to FIG. 1, an embodiment of a method 10 described herein is illustrated. At box 12, a radiation curable material is applied to a surface of an identification document. The radiation curable material can be applied by an applicator mechanism that applies the radiation curable material to the surface. For example, if the radiation curable material is a topcoat material, the applicator mechanism can be a topcoat applicator mechanism. An example of a topcoat applicator mechanism that can be used is the topcoat module used in the MX6100 Card Issuance System available from Entrust Datacard Corporation of Shakopee, Minn. If the radiation curable material is a radiation curable printing ink, the applicator mechanism can be a drop-on-demand printing mechanism. An example of a drop-on-demand printing mechanism that can be used is available from Industrial Inkjet Ltd (IIJ) of Cambridge, UK.

Thereafter, at box 14, one or more processing operations are performed on the identification document. In this embodiment, the one or more processing operations can be performed before any curing of the radiation curable material. The one or more processing operations are performed by at least one identification document processing mechanism that is located downstream of the applicator mechanism along a document transport path. The identification document is transported by a suitable transport mechanism, such as rollers and/or belts, from the applicator mechanism to the at least one document processing mechanism along the document transport path. A single document processing mechanism can perform each processing operation, or separate document processing mechanisms can be provided for each processing operation.

Thereafter, at box 16, after the one or more processing operations have been performed, the radiation curable material is fully cured. The curing of the radiation curable material is performed by one or more radiation curing stations into which the identification document is transported by a suitable transport mechanism, such as rollers and/or belts, from the at least one processing mechanism. The one or more radiation curing stations are located downstream of the at least one processing mechanism along the document transport path. In one embodiment, the one or more radiation curing stations are configured to apply UV radiation to the radiation curable material to completely cure the radiation curable material. However, other forms of radiation can be used.

FIG. 2 illustrates another embodiment of a method 20 described herein. In this embodiment, a partial cure of the radiation curable material occurs before performing the one or more processing operations. In particular, in the method 20, at box 22, a radiation curable material is applied to a surface of an identification document in a similar manner as box 12 in the method 10 of FIG. 1.

Thereafter, at box 24, the radiation curable material is partially cured. The partial curing of the radiation curable material is performed by one or more radiation curing stations into which the identification document is transported by a suitable transport mechanism, such as rollers and/or belts, from the applicator mechanism used at box 22. The one or more radiation curing stations are located downstream of the applicator mechanism along the document transport path. In one embodiment, the one or more radiation curing stations used in box 24 are configured to apply UV radiation to the radiation curable material to partially cure the radiation curable material. However, other forms of radiation can be used.

Thereafter, at box 26, one or more processing operations are performed on the identification document. Similar to the discussion above for box 14 of the method 10 in FIG. 1, the one or more processing operations are performed by at least one identification document processing mechanism that is located downstream of the applicator mechanism along the document transport path. The identification document is transported by a suitable transport mechanism, such as rollers and/or belts, from the one or more curing stations to the at least one document processing mechanism along the document transport path.

Thereafter, at box 28, after the one or more processing operations have been performed, the radiation curable material is fully cured. The full curing of the radiation curable material is performed by one or more radiation curing stations into which the identification document is transported by a suitable transport mechanism, such as rollers and/or belts, from the at least one processing mechanism. The one or more radiation curing stations are located downstream of the at least one processing mechanism along the document transport path. In one embodiment, the one or more radiation curing stations are configured to apply UV radiation to the radiation curable material to completely cure the radiation curable material. However, other forms of radiation can be used.

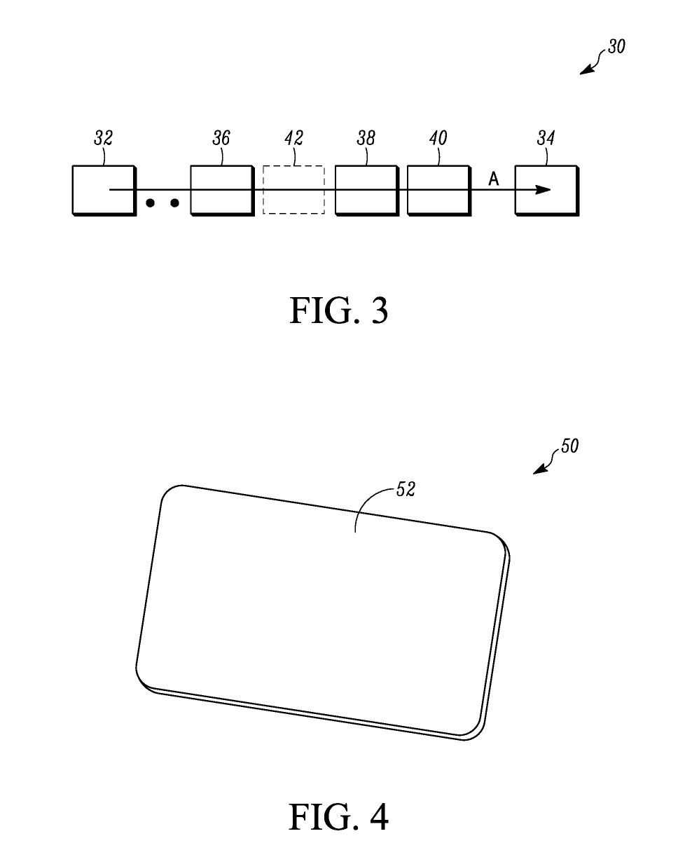

FIG. 3 illustrates an example of a document processing system 30 that can be used to implement the methods 10 and 20 in FIGS. 1 and 2. The document processing system 30 can have any configuration suitable for implementing either or both of the methods 10, 20. So in the case of the method 10, the system 30 includes the ability to apply a radiation curable material to a surface of an identification document, thereafter perform one or more processing operations on the identification document, and thereafter fully cure the radiation curable material after the one or more processing operations. In the case of the method 20, the system 30 includes the ability to apply a radiation curable material to a surface of an identification document, thereafter partially cure the radiation curable material, thereafter perform one or more processing operations on the identification document, and thereafter fully cure the radiation curable material after the one or more processing operations.

The system 30 illustrated in FIG. 3 is referred to as a central issuance processing system that is typically designed for large volume batch processing of identification documents, often employing multiple processing stations or modules to process multiple identification documents at the same time to reduce the overall per document processing time. Examples of central issuance identification document processing systems include the MX and MPR family of central issuance systems available from Entrust Datacard Corporation of Shakopee, Minn. Other examples of central issuance systems are disclosed in U.S. Pat. Nos. 4,825,054, 5,266,781, 6,783,067, and 6,902,107, all of which are incorporated herein by reference in their entirety.

The system 30 can alternatively be configured as a desktop identification document processing system that is typically designed for relatively small scale, individual document processing. In desktop processing systems, a single document to be processed is input into the system, processed, and then output. These systems are often termed desktop machines or printers because they have a relatively small footprint intended to permit the machine to reside on a desktop. Many examples of desktop machines are known, such as the SD or CD family of desktop identification document machines available from Entrust Datacard Corporation of Shakopee, Minn. Other examples of desktop identification document machine are disclosed in U.S. Pat. Nos. 7,434,728 and 7,398,972, each of which is incorporated herein by reference in its entirety.

Returning to FIG. 3, the system 30 includes an identification document input 32, an identification document output 34, an applicator mechanism 36 that applies a radiation curable material to a surface of an identification document, one or more identification document processing mechanisms 38 that perform a processing operation on the identification document, and one or more radiation curing stations 40 that fully cures the radiation curable material. In the case of the method 20, the system 30 can optionally include one or more radiation curing stations 42 that partially cures the radiation curable material. In addition, the system 30 includes a document transport path, indicated by the arrow A, that extends from the input 32 to the output 34 and along which an identification document is transported through the system 30 by suitable document transport mechanisms that are well known in the art.

The identification document input 32 is a mechanism by which an identification document to be processed is input into the system 30 along the transport path A. In one embodiment, the input 32 can be configured to hold a plurality of identification documents, for example tens, hundreds, or even thousands of documents, waiting to be processed, and which are fed one-by-one by a suitable feed mechanism known in the art into the transport path A. In another embodiment, the input 32 can be a single-feed input slot through which identification documents are manually fed one-by-one into the system 30.

The identification document output 34 is disposed at the end of the transport path A and is configured to receive each identification document after it has been processed in the system 30. In one embodiment, the output 34 can be configured to collect a plurality of processed identification documents, for example tens, hundreds, or even thousands of documents, one-by-one after they have been processed. In another embodiment, the output 34 can be an output slot through which processed identification documents are discharged one-by-one from the system 30 after processing.

The applicator mechanism 36, which can be of a type as described above, is configured to apply a radiation curable material to a surface of an identification document. The applicator mechanism 36 is located along the transport path A between the identification document input 32 and the identification document output 34, downstream from the input 32. If desired, one or more document processing mechanisms, such as one or more printers, a magnetic stripe reader/encoder, an integrated circuit chip reader/programmer, and the like, can be positioned between the input 32 and the applicator mechanism 36 and through which the identification document travels before reaching the applicator mechanism 36. In other embodiments, a magnetic stripe reader/encoder and/or an integrated circuit chip reader/programmer can be positioned between the applicator mechanism 36 and the identification document output 34. Examples of circuit chip programming stations are disclosed in U.S. Pat. No. 6,695,205, which is incorporated herein by reference in its entirety.

In the case of the method 10, after the radiation curable material is applied to the document surface, the identification document is transported along the transport path A to the at least one identification document processing mechanism 38 to perform one or more processing operations on the identification document prior to completely curing the radiation curable material. The at least one identification document processing mechanism 38 is located between the applicator mechanism 36 and the identification document output 34, for example between the applicator mechanism 36 and the radiation curing station(s) 40. The processing mechanism(s) 38 can be configured to perform, but is not limited to performing, one or more of embossing characters on the identification document, applying a topping coloration material to the embossed characters, indenting characters into the document, thermal or laser printing, and applying a hot stamp security feature.

The radiation curing station(s) 42 can be included with the system 30, and in the case of the method 10, an identification document can simply be transported through the station(s) 42 without any curing occurring. In the case of the method 20, the identification document is transported into the one or more radiation curing stations 42 and the radiation curable material is exposed to radiation to partially cure the radiation curable material. After partial curing is completed, the document is transported on to the processing mechanism(s) 38.

From the processing mechanism(s) 38, the document is transported to the radiation curing station(s) 40. The radiation curing station(s) 40 is located between the at least one identification document processing mechanism 38 and the identification document output 34. In the curing station(s) 40, the radiation curable material is exposed to radiation to fully cure the radiation curable material. The full cure of the material can occur in a single curing station 40. Alternatively, two or more curing stations 40 can be provided, each of which applies a portion of radiation to result in complete curing of the material.

After full curing, the document is transported to the output 34. Optionally, one or more additional document processing mechanisms can be located between the curing station(s) 40 and the output 34 to perform additional processing on the document after the material is fully cured.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method comprising:
applying a radiation curable material to a surface of an identification document;
thereafter, performing one or more processing operations on the identification document; and
fully curing the radiation curable material after the one or more processing operations.

2. The method of claim 1, wherein after applying the radiation curable material and before the one or more processing operations, partially curing the radiation curable material.

3. The method of claim 2, wherein a radiation dosage employed during the partially curing step is lower than a radiation dosage employed during the fully curing step.

4. The method claim 1, wherein the radiation curable material is curable by ultra-violet radiation.

5. The method of claim 1, wherein the radiation curable material comprises a topcoat, a printing ink, a protective varnish, or combinations thereof

6. The method of claim 1, wherein the one or more processing operations comprise one or more of embossing, topping embossed characters, indenting, printing, or hot stamping.

7. The method of claim 1, wherein the identification document is a plastic card, a passport, or a page of a passport.

8. The method of claim 1, wherein the radiation curable material is applied to the surface of the identification document by a drop-on-demand printing mechanism.

9. The method of claim 1, wherein the surface is a front surface of the identification document or a rear surface of the identification document.

10. An identification document processing system, comprising:
an identification document input;
an identification document output downstream from the identification document input;
a radiation curable material applicator mechanism that applies a radiation curable material to a surface of an identification document, the radiation curable material applicator mechanism is located between the identification document input and the identification document output;
at least one identification document processing mechanism that performs a processing operation on the identification document, the at least one identification document processing mechanism is located between the radiation curable material applicator mechanism and the identification document output; and
a radiation curing station that cures the radiation curable material applied to the surface of the identification document, the radiation curing station is located between the at least one identification document processing mechanism and the identification document output.

11. The identification document processing system of claim 10, further comprising:
an additional radiation curing station that cures the radiation curable material applied to the surface of the identification document, the additional radiation curing station is located between the radiation curable material applicator mechanism and the at least one identification document processing mechanism.

12. The identification document processing system of claim 10, wherein the identification document is a plastic card, a passport or a page of a passport.

13. The identification document processing system of claim 10, further comprising a station adapted to read and/or write data to a circuit chip embedded in the identification document.

14. The identification document processing system of claim 10, further comprising a station adapted to read and/or write data to a magnetic stripe of the identification document.

15. The identification document processing system of claim 10, wherein the radiation curable material applicator mechanism comprises a drop-on-demand printing mechanism.

16. The identification document processing system of claim 10, wherein the at least one identification document processing mechanism comprises an embossing mechanism.
